(19) United States
(12) Patent Application Publication
(10) Pub. No.: US 2019/0016582 A1
(43) Pub. Date: Jan. 17, 2019

(54) AUTOMATIC LIQUID INJECTION SYSTEM

(71) Applicants: HYUNDAI MOTOR COMPANY, Seoul (KR); KIA MOTORS CORPORATION, Seoul (KR)

(72) Inventors: Jung Whan Yeum, Seoul (KR); Jung Su Gong, Anyang-si (KR); Jin Young Hong, Yongin-si (KR)

(73) Assignees: HYUNDAI MOTOR COMPANY, Seoul (KR); KIA MOTORS CORPORATION, Seoul (KR)

(21) Appl. No.: 15/832,676

(22) Filed: Dec. 5, 2017

(30) Foreign Application Priority Data
Jul. 11, 2017 (KR) 10-2017-0087968

(51) Int. Cl. B67D 7/02; B67D 7/04; B67D 7/40; B67D 7/42

(52) U.S. Cl. CPC B67D 7/0288; B67D 7/42; B67D 7/40; B67D 7/04

(57) ABSTRACT

An automatic liquid injection system for use in a vehicle production line is disclosed. The automatic liquid injection system includes a robot controlling a position of a robot arm, an injection gun installed at a front end portion of the robot arm, a vision installed on one side of the injection gun and imaging an inlet provided in a vehicle, and a controller sensing a position of the inlet through the vision and controlling a position of the robot arm through the robot to fasten the injection gun to the inlet.

### CROSS-REFERENCE TO RELATED APPLICATION

This application claims priority to and the benefit of Korean Patent Application No. 10-2017-0087968 filed in the Korean Intellectual Property Office on Jul. 11, 2017, the entire contents of which are incorporated herein by reference.

### BACKGROUND

### (a) Field

The present invention relates to an automatic liquid injection system for automatically injecting an injection liquid into an inlet provided in a vehicle to enhance productivity, reduce a load of an operator, and enhance reliability regarding an injection process.

### (b) Description of Related Art

Generally, in an automobile manufacturing plant, in particular, in a design factory, various electric/electronic components, internal components, and the like, are assembled to a car body which has completely undergone a painting process, and before the car body is transported to a complete car line, an engine and transmission lubricant, antifreeze, brake fluid, power pump hydraulic oil, air-conditioner refrigerant, washer liquid, and the like, are injected through an injector.

The above information disclosed in this Background section is only for enhancement of understanding of background of the invention. Applicant notes that this section may contain information available before this application. However, by providing this section, Applicant does not admit that any information contained in this section constitutes prior art.

The disclosure of this section is to provide background of the invention.

### SUMMARY

A vehicle injection apparatus is configured such that a main body (also called “console” or “carriage”) is movable in a transport direction of the vehicle along a guide rail, and an injection liquid storage tank is installed within the main body. In the main body, an injection gun is held and connected to the injection liquid storage tank through an injection hose.

Thus, when the vehicle enters a workshop through a conveyer system, an operator pulls down the injection gun and fastens the injection gun to a reservoir tank of the vehicle during a process of transferring the vehicle. Since the vehicle is being transferred through a conveyer, excessive tension may act on the injection hose due to a limited length of the injection hose to cause the injection gun to be released from the reservoir tank of the vehicle.

Also, when the operator does not release the injection gun from the injection liquid reservoir tank of the vehicle at the time when injection of the injection liquid terminates, the injection liquid reservoir tank of the vehicle may be damaged by the injection gun. In addition, since the operator manually connects or separates the injection gun, the injection liquid may be injected by mistake, may not be injected, or an injection amount of the liquid may be insufficient due to misjudgement of the operator.

The present disclosure has been made in an effort to provide an automatic liquid injection system and an automatic liquid injection method having advantages of improving an error of an operator by automating a liquid injection process and effectively coping with a synchronization error occurring due to a difference in movement rate between an inlet of a vehicle and a console.

The present disclosure has also been made in an effort to provide an automatic liquid injection system and an automatic liquid injection method having advantages of allowing an operator to promptly cope with a facility error situation during the same process through a structure in which an injection gun and an injection robot are separated.

An embodiment of the present invention provides an automatic liquid injection system including: a robot controlling a position of a robot arm; an injection gun installed at a front end portion of the robot arm; a vision installed on one side of the injection gun and imaging (or capturing an image of) an inlet provided in a vehicle; and a controller sensing a position of the inlet through the vision and controlling a position of the robot arm through the robot to fasten the injection gun to the inlet.

The automatic liquid injection system may further include: a conveyer moving the vehicle at a set rate (or at a set speed); a carriage moving above the vehicle in a movement direction of the vehicle; and a console installed under the carriage, wherein the robot is installed in the console.

The automatic liquid injection system may further include: a clamp fixed to a lower portion of a front end portion of the robot arm and fastened to or separated from an upper end of the injection gun; an injection hose connected to the injection gun in one end to supply a liquid to the injection gun; an unwinder roll rotatably mounted on a front end portion of the robot arm to wind the injection hose by a set force; and an encoder sensing a rotation position of the unwinder roll.

The controller may calculate an unwound length of the injection hose from a rotation position of the unwinder roll sensed by the encoder.

The controller may lower the front end portion of the robot such that the injection gun is fastened to the inlet.

In a state in which the injection gun is fastened to the inlet, the controller may unclamp the clamp to separate the clamp from the injection gun.

In a state in which the clamp is unclamped from the injection gun, the controller may lift the front end portion of the robot arm, and the injection hose may be unwound from the unwinder roll according to an increase in a distance between the injection gun and the unwinder roll.

The controller may calculate the distance between the unwinder roll and the injection gun from a sensing signal from the encoder.

When a preset amount of liquid is injected to the inlet through the injection hose and the injection gun, the controller may correct a position of the clamp in a horizontal direction such that the clamp is positioned right above the injection gun according to the calculated distance.

After correcting the position of the clamp in the horizontal direction, the controller may lower the front end portion of the robot arm such that the clamp matches the upper end portion of the injection gun and clamps the upper end portion of the injection gun.

The controller may lift the front end portion of the robot arm to separate the front end portion from the injection gun and return the robot arm to an initial position.

Another embodiment of the present invention provides a method for controlling an automatic liquid injection system including a robot controlling a position of a robot arm, an injection gun installed at a front end portion of the robot arm, and a vision installed on one side of the injection gun and imaging an inlet provided in a vehicle, including: imaging the inlet of the vehicle using the vision; and controlling a position of the robot arm to fasten the injection gun to the inlet.

The method may further include: moving the vehicle at a set rate using the conveyer; and installing the robot in a console and moving the console above the vehicle in a movement direction of the vehicle.

The method may further include: clamping or unclamping an upper end of the injection gun using a clamp fixed to a front end of the robot arm; supplying a liquid to the injection gun through an injection hose; winding the injection hose connected to the injection gun by a set force using an unwinder roll; and sensing a rotation position of the unwinder roll using an encoder.

The method may further include: clamping or separating an upper end of the injection gun using the clamp; supplying a liquid to the injection gun using an injection hose; winding the injection hose connected to the injection gun by a set force using the unwinder roll; and sensing a rotation position of the unwinder roll using the encoder.

The method may further include: calculating a length of the injection hose unwound from a rotation position of the unwinder roll sensed by the encoder.

The method may further include: lowering a front end portion of the robot such that the injection gun is fastened to the inlet.

The method may further include: unclamping the clamp to separate the clamp from the injection gun in a state in which the injection gun is fastened to the inlet. The method may further include: lifting the front end portion of the robot arm in a state in which the clamp is unclamped from the injection gun, wherein the injection hose may be unwound from the unwinder roll according to an increase in distance between the injection gun and the unwinder roll.

A distance between the unwinder roll and the injection gun may be calculated from a sensing signal from the encoder.

In the automatic liquid injection system according to an embodiment of the present invention, since the injection gun is automatically fastened to the inlet using the vision and the robot and the injection is injected, productivity and reliability may be enhanced.

Also, since the structure in which the robot arm automatically attaches and detaches the injection gun is employed, the injection gun may more stably perform an injection operation.

In addition, a synchronization error between the injection gun and the robot may be effectively removed using an unwound length of the injection hose between the injection gun and the unwinder.

### BRIEF DESCRIPTION OF THE DRAWINGS

FIG. 1 is an overall side view of a liquid injection system.

FIG. 2 is a partial side view of an automatic liquid injection system according to an embodiment of the present invention.

FIG. 3 is a cross-sectional view of an unwinder in an automatic liquid injection system according to an embodiment of the present invention.

FIG. 4 is a schematic flow chart illustrating an automatic liquid injection method according to an embodiment of the present invention.

FIGS. 5 to 12 are partial side views illustrating each step of an automatic liquid injection method according to an embodiment of the present invention.

FIG. 13 is a flow chart illustrating an automatic liquid injection method according to an embodiment of the present invention.

FIG. 14 is a detailed flow chart illustrating some steps of automatic liquid injection method according to an embodiment of the present invention.

FIG. 15 is a view illustrating a configuration of an automatic liquid injection system according to an embodiment of the present invention.

### DETAILED DESCRIPTION

Hereinafter, the present invention will be described in detail with reference to the accompanying drawings.

In the drawings, sizes and thickness of components are arbitrarily shown for the description purposes, so the present invention is not limited to the illustrations of the drawings and thicknesses are exaggerated to clearly express various parts and regions.

To clarify the present invention, parts irrespective of description are omitted and like numbers refer to like elements throughout the specification.

In the following descriptions, terms such as “first” and “second,” etc., may be used only to distinguish one component from another as pertinent components are named the same, and order thereof is not limited.

An aspect of the present invention provides a method for controlling an automatic liquid injection device for use in a vehicle production line. At least one computing device (controller 155) of the vehicle production line controls robot 250 that is fixed (mounted) to console 200. In embodiments, at a workplace for liquid injection of the vehicle production line, the vehicle body 140 is moving at a predetermined speed on conveyer 150 and the console 200 moves at the same speed by the carriage 110 along the rail 100.

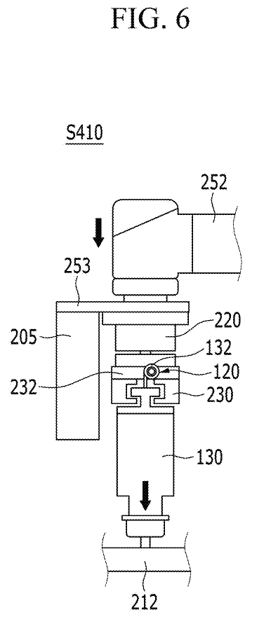

When the vehicle body 140 moves in the workplace, using data from at least one vision sensor 205, controller 155 determines location of a liquid inlet 210 (fixed to a vehicle body) when the vehicle body 140 and the robot is at a first predetermined location (zone) of the workspace. Then, the controller controls robotic arm 252 holding a liquid injector (injection gun) to place the liquid injector 130 over the liquid inlet and, subsequently, to insert (connect) the liquid injector into the liquid inlet. (FIG. 6). In embodiments, the liquid injector is aligned with the liquid inlet and inserted while the robot is moving together with the vehicle body as console 200 and conveyer 150 operate at the same speed. In embodiments, the liquid injector is inserted into (connected to) the inlet 210 and separated from the robot arm when the vehicle body and the robot are at a second predetermined location (zone) of the workspace next to the first predetermined location (zone).

Subsequently, while the vehicle body continues to move to a third predetermined zone after the second predetermined zone, the robot does not follow the vehicle body and remain in the second zone. As the vehicle body moves, the roller (unwinder 120) releases the injection hose according to a distance between the injector and the roller. Liquid is supplied to the reservoir 212 when the vehicle is in the third predetermined zone. In embodiments, the robot stops after releasing the clamp 230 until a next command to follow the vehicle body. In embodiments, after releasing the clamp 230, the robot moves to the end of the second zone and waits until a command to follow the vehicle body for picking up the liquid injector.

Subsequently, the controller determines completion of liquid injection, the controller controls the carriage 110 to move the robot over the inlet at a fourth predetermined zone of the workplace. The controller then controls the robot arm to align it over the inlet, to pick up the inlet at the fourth predetermined zone using data from the encoder and based on a length of the injection hose connecting the roller and the injection gun (or a length of the injection hose released since separation of the injection gun at the second zone of the workplace).

Subsequent to picking up the injection gun, the controller controls the carriage 110 to move the robot back to the first predetermined zone of the workspace. When another vehicle body moves in the first zone, the controller initiates a process to locate a liquid inlet.

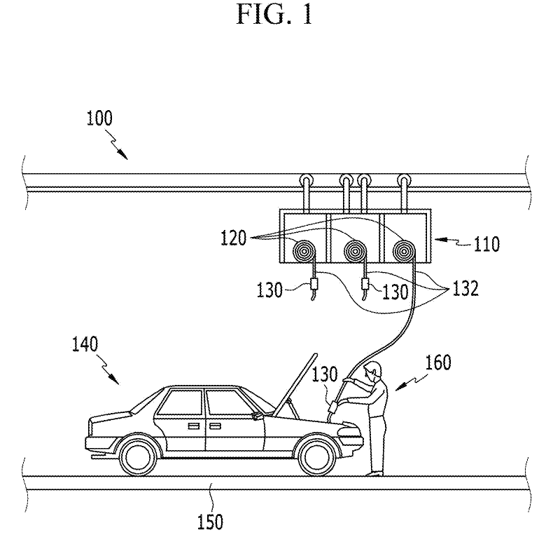

FIG. 1 is an overall side view of a liquid injection system related to embodiments of the present invention.

Referring to FIG. 1, the liquid injection system includes a rail 100, a carriage 110, an unwinder 120, an injection hose 132, an injection gun 130, an operator 160, a vehicle 140, and a conveyer 150.

The vehicle 140 is disposed on the conveyer 150, and the conveyer 150 moves the vehicle 140 in one direction (in a rightward direction of the drawing) at a set uniform rate (or at a uniform speed).

The rail 100 is installed in a movement direction of the vehicle 140 above the vehicle 140 and spaced apart from the roof of the vehicle 140. The carriage 110 (or a console) is installed in the rail 100, and the carriage 110 moves at a set rate in the movement direction of the vehicle 140 along the rail 100.

A tank filled with an injection liquid is disposed within the carriage 110, the injection hose 132 is connected to the tank, and the injection gun 130 is disposed at an end portion of the injection hose 132. Also, the unwinder 120 around which the injection hose 132 is wound is disposed in the carrier 110, and the unwinder 120 wind the injection hose 132 by a predetermined inverse-rotational power.

In an embodiment of the present invention, when the operator 160 pulls down the injection gun 130 connected to the unwinder 120 of the carriage 110, the injection hose 132 is unwound from the unwinder 120.

Also, the operator 160 fastens the injection gun 130 to an inlet 210 and presses a liquid injection. When injection of the liquid is completed, the injection gun 130 is separated from the inlet 210, the injection hose 132 is wound around the unwinder 120 by inverse-rotational power of the unwinder 120, and the injection gun 130 is returned to the unwinder 120.

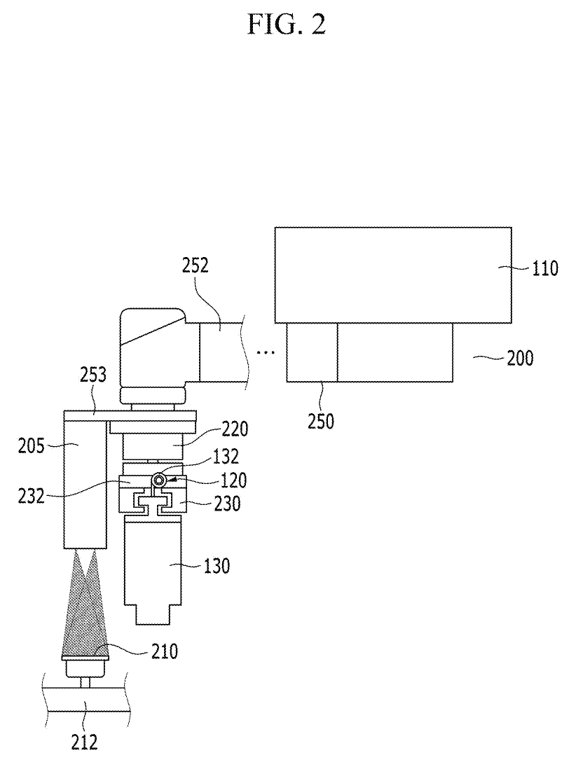

FIG. 2 is a partial side view of an automatic liquid injection system according to an embodiment of the present invention.

Referring to FIG. 2, the automatic liquid injection system includes the carriage 110, a console 200, a robot 250, a robot arm 252, a bracket 253, a vision 205, a floating mount 220, the unwinder 120, a clamp body 232, a clamp 230, the injection gun 130, an inlet 210, and a liquid reservoir 212.

The carriage 110 moves in the movement direction of the vehicle 140 along the rail 100, the console 200 is mounted below the carriage 110, and the robot 250 is configured at one end of the console 200.

The robot arm 252 may be disposed in the robot 250, and the robot 250 may control a position of the robot arm 252 with respect to six axes.

The bracket 253 is fixed to a lower end of a front end portion of the robot arm 252, and the vision 205 is disposed on one side of a lower surface of the bracket 253. The floating mount 220 is disposed on the other side of a lower surface of the bracket 253. The clamp body 232 is disposed at a lower end of the floating mount 220.

The clamp body 232 may be moved by the floating mount 220 within a set distance in a horizontal direction or vertical direction with respect to the bracket 253. Here, a structure, or the like, of the floating mount 220 may refer to a known art.

The clamp 230 which may be separated to both sides is disposed at a lower end of the clamp body 232. The clamp 230 is coupled to each other to clamp an upper end of the injection gun 130.

An upper end of the injection gun 130 is clamped by the clamp 230, and a lower end of the injection gun 130 is oriented to a lower side where the inlet 210 is disposed. Here, the inlet 210 may be disposed in an engine room of the vehicle 140.

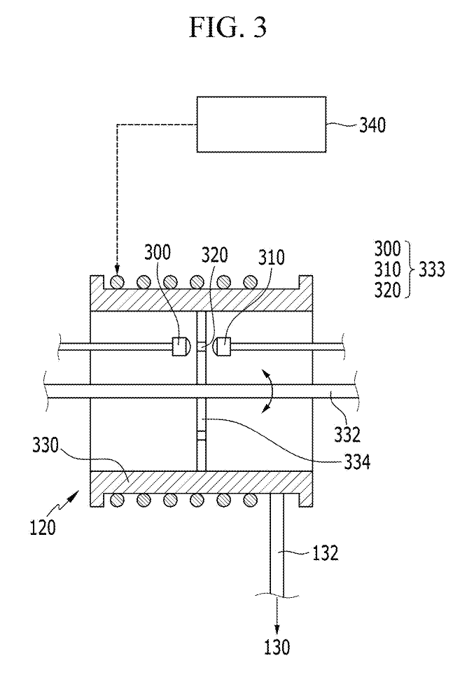

The unwinder 120 is disposed in the clamp body 232, the injection hose 132 is wound around the unwinder 120, and an end portion thereof is connected to an upper end of the injection gun 130. The injection hose 132 may be connected to a supply unit (340 of FIG. 3) and supply an injection liquid filled in the supply unit 340 to the injection gun.

Here, the unwinder may be mounted at a front end portion of the robot arm or may be mounted on any one component mounted at the front end portion of the robot arm.

FIG. 3 is a cross-sectional view of an unwinder in an automatic liquid injection system according to an embodiment of the present invention.

Referring to FIG. 3, the unwinder 120 includes an unwinder roll 330, the unwinder roll 330 rotates together with a rotational shaft 332, and the injection hose 132 is wound around an outer circumferential surface of the unwinder roll 330.

One side of the injection hose 132 is wound around the unwind roll 330 and an end portion thereof is connected to the injection gun 130 to transmit the injection liquid from the supply unit 340 to the injection gun 130.

An encoder 333 is disposed on an inner side of the unwinder roll 330. The encoder 333 includes a light receiving element 300, a light emitting element 310, and a rotary plate 334 having slits 320. Here, the rotary plate 334 rotates together with the unwinder roll 330 and the rotational shaft 332, and the slits 320 are arranged at a preset interval in a rotation direction on the rotary plate.

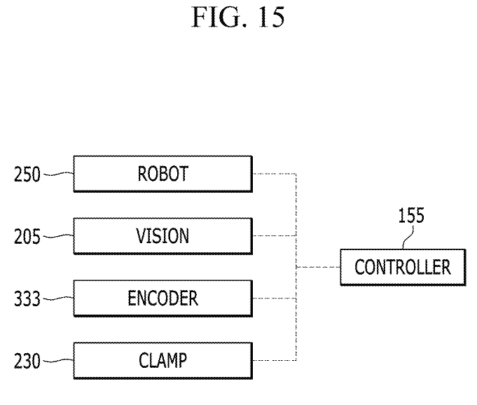

The light emitting element 310 may irradiate light through the slits 320, the light receiving element 300 sense light coming through the slits 320, and the controller (155 of FIG. 15) may calculate an unwinding amount of the injection hose 132 according to rotation of the unwinder roll 330.

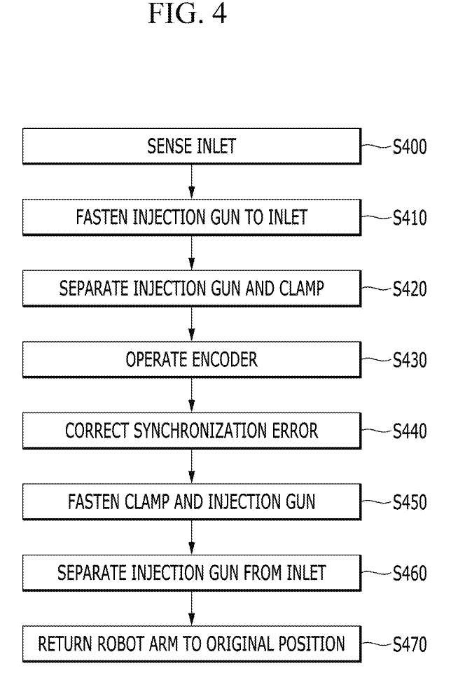

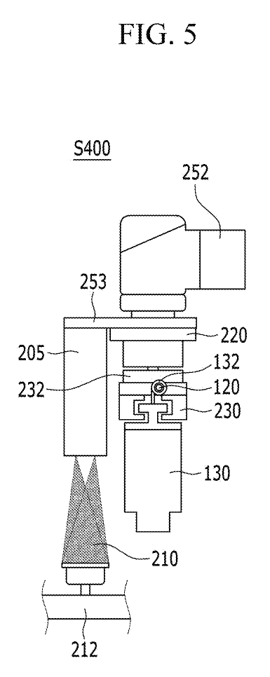

FIG. 4 is a schematic flow chart illustrating an automatic liquid injection method according to an embodiment of the present invention and FIGS. 5 to 12 are partial side views illustrating each step of an automatic liquid injection method according to an embodiment of the present invention.

Referring to FIGS. 4 and 5, in operation S400, the vision 205 senses the inlet 210. In operation S410, referring to FIG. 6, the controller (155 of FIG. 15) senses a position of the inlet 210 and controls the robot 250 to insert and fasten a lower nozzle of the injection gun 130 into the inlet 210.

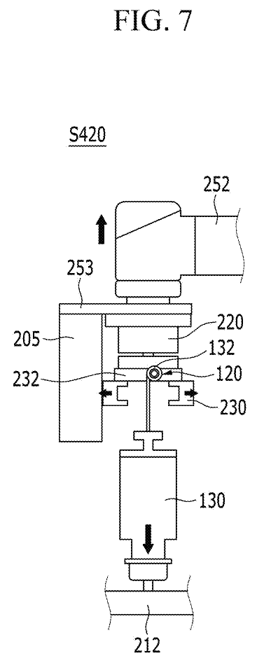

Referring to FIGS. 4 and 7, in operation S420, the clamp 230 unclamps an upper end of the injection gun 130, the robot 250 lifts a front end portion of the robot arm 252, and the clamp 230 and the injection gun 130 are separated up and down.

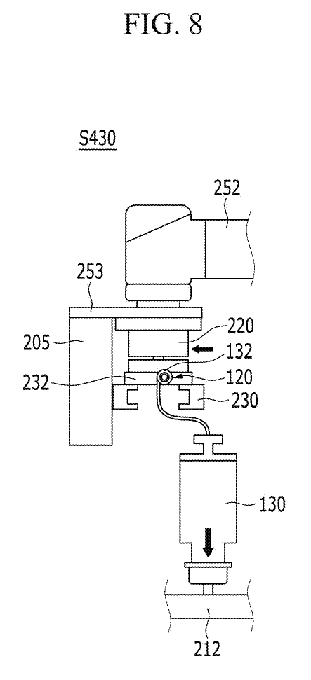

Referring to FIGS. 4 and 8, in operation S430, as the encoder 333 operates, the controller 155 may calculate a distance between the injection gun 130 and the clamp 230 or a length of the injection hose 132 unwound from the unwinder 120.

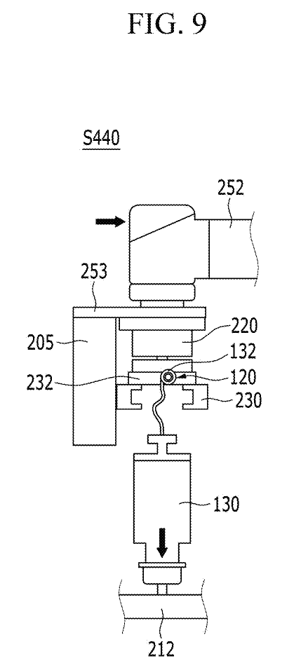

Referring to FIGS. 4 and 9, in operation S440, the controller 155 may correct a position error between a front end portion of the robot arm 252 and the injection gun 130 in a horizontal direction using the unwound length of the injection hose 132 to correct and remove a synchronization error.

That is, the controller 155 removes or reduces a difference in distance between the injection gun 130 fastened to the inlet 210 and the clamp 230 fixed to a lower portion of the front end portion of the robot arm 252 in a horizontal direction.

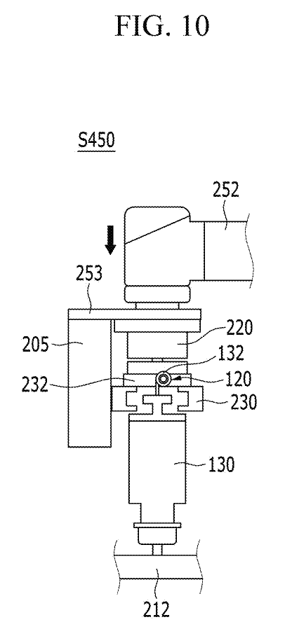

Referring to FIGS. 4 and 10, in operation S450, the controller 155 lowers the front end portion of the robot arm 252 to fasten the clamp 230 and an upper end of the injection gun 130 to each other.

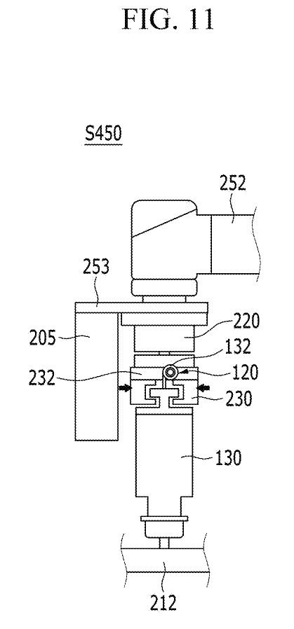

Referring to FIGS. 4 and 11, in operation S450, the controller clamps the clamp 230 to an upper end portion of the injection gun 130.

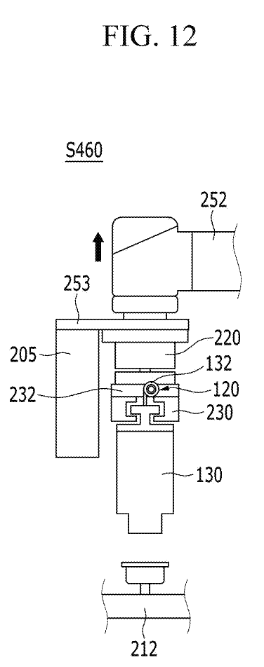

Also, referring to FIGS. 4 and 12, in operation S460, the controller 155 lifts the front end portion of the robot arm 252 to separate the injection gun 130 and the inlet 210 from each other, and in operation S470, the controller 155 returns the robot arm 252 to an initial position thereof.

Referring back to FIG. 7, when the front end portion of the robot arm is lifted, a weight of the injection gun is greater than a force of the unwinder to pull the injection hose in order to maintain a state in which the injection gun is fastened to the inlet.

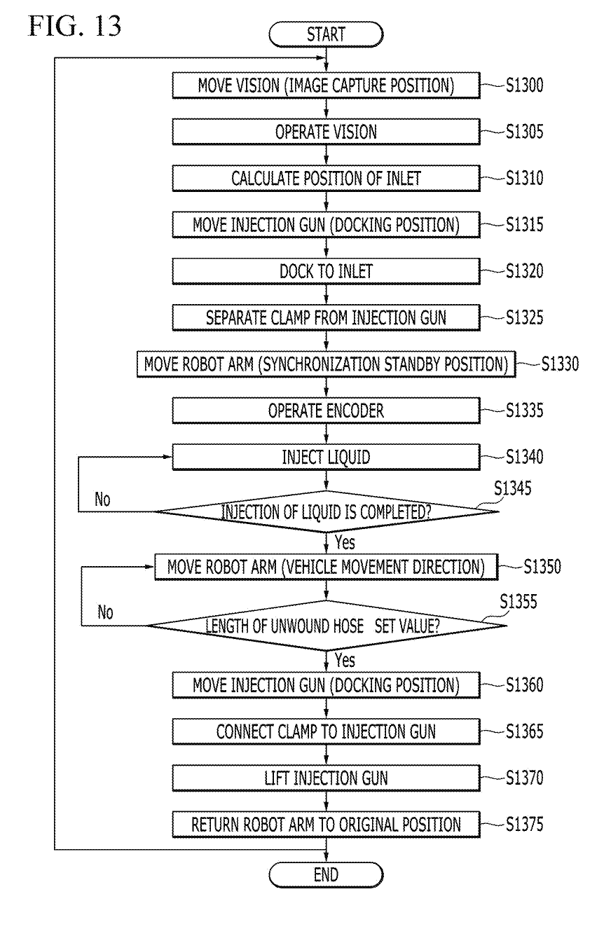

FIG. 13 is a flow chart illustrating an automatic liquid injection method according to an embodiment of the present invention.

Referring to FIG. 13, as control starts, the controller 155 moves the vision 205 to an image capture position through the robot 250 in operation S1300. In operation S1305, the controller 155 operates the vision 205 to capture an image of the inlet 210.

In operation S1310, the controller 155 calculates a position of the inlet 210, or the like, and in operation S1315, the controller 155 moves the injection gun 130 in a horizontal direction to position the injection gun 130 in a portion directly above the inlet 210.

In operation S1320, the controller 155 lowers the robot arm 252 and inserts and fastens the injection gun 130 into the inlet 210, and in operation S1325, the clamp 230 is unclamped from an upper end of the injection gun 130.

In operation S1330, as the front end portion of the robot arm 252 is lifted, the clamp 230 is moved to a synchronization standby position, and in operation S1335, the encoder 333 operates.

In operation S1340, a liquid is injected to the inlet 210 through the injection hose 132 and the injection gun 130, and in operation S1345, it is determined whether injection of the liquid is completed. Here, whether injection of the liquid is completed may be determined by a flow meter measuring a flow rate of the injected liquid, an injection time, the operator, and the like, and this may refer to the known art.

In operation S1350, the controller 155 moves the front end portion of the robot arm 252 in a movement direction of the vehicle, and in operation S1335, it is determined whether an unwound length of the injection hose 132 is smaller than or equal to a set value. Here, when it is determined that the unwound length of the injection hose 132 is smaller than or equal to the set value, operation S1360 is performed, and when the unwound length of the injection hose 132 is greater than the set value, operation S1350 is performed.

In operation S1360, the controller 155 moves the robot arm 252 to a docking position so that the clamp 230 may be fastened to an upper end of the injection gun 130.

In operation S1365, the controller 155 clamps the upper end of the injection gun 130 using the clamp 230, and in operation S1370, the controller 155 lifts the front end portion of the robot arm 252 to lift the injection gun 130.

In operation S1375, the controller 155 returns the robot arm 252 to an initial position thereof, and terminates controlling or performs operation S1300 again.

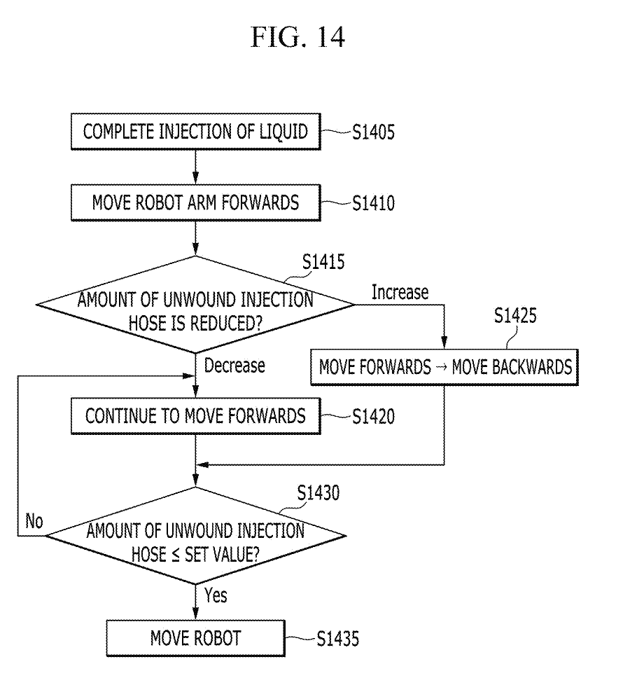

FIG. 14 is a detailed flow chart illustrating some steps of automatic liquid injection method according to an embodiment of the present invention.

Referring to FIG. 14, in operation S1405, injection of the liquid is completed, and in operation S1410, the robot arm 252 is moved forwards in the movement direction of the vehicle.

In operation S1415, the controller 155 determines whether an unwinding amount of the injection hose 132 is reduced using a sensing signal from the encoder 333. When the unwinding amount of the injection hose 132 is reduced, the controller 155 continues to move the robot arm 252 forwards in operation S1420. Also, when the unwinding amount of the injection hose 132 is increased, the controller 155 moves the robot arm 252 backwards in operation S1425.

In operation S1430, the controller 155 determines whether the unwinding amount of the injection hose 132 is smaller than or equal to the set value, and when the unwinding amount of the injection hose is smaller than or equal to the set value, the controller 155 lowers the front end portion of the robot arm 252 and connects the clamp 230 and the upper end of the inlet 210 to each other in operation S1435.

FIG. 15 is a view illustrating a configuration of an automatic liquid injection system according to an embodiment of the present invention.

Referring to FIG. 15, the automatic liquid injection system includes the robot 250, the vision 205, the encoder 333, and the clamp 230 as control targets, and the controller 155 is electrically connected thereto.

The controller 155 may sense a target from an image capture signal through the vision 205, calculate an unwinding amount of the injection hose 132 through the encoder 333, and calculate a difference in position between the clamp 230 and the inlet 210 in a horizontal direction using the unwinding amount.

The controller 155 may clamp or unclamp the upper end of the inlet 210 using the clamp 230, and control a position of the clamp 230 and a position of the inlet 210 by controlling the robot 250.

The controller may be implemented as one or more microprocessors operated by a set program, and the set program may include a series of commands for performing the method according to an embodiment of the present invention.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

100: rail 110: carriage
120: unwinder 130: injection gun
132: injection hose 140: vehicle
150: conveyor 155: controller
160: operator 200: console
205: vision 210: inlet
212: liquid reservoir 220: floating mount
230: clamp 232: clamp body
250: robot 252: robot arm
253: bracket 300: light receiving element
310: light emitting element 320: slit
330: unwinder roll 332: rotational shaft
333: encoder 334: rotary plate
340: supply unit

What is claimed is:

1. An automatic liquid injection system comprising:
a robot controlling a position of a robot arm;
an injection gun installed at a front end portion of the robot arm;
a vision installed on one side of the injection gun and imaging an inlet provided in a vehicle; and
a controller sensing a position of the inlet through the vision and controlling a position of the robot arm through the robot to fasten the injection gun to the inlet.

2. The automatic liquid injection system of claim 1, further comprising:
a conveyer moving the vehicle at a set rate;
a carriage moving above the vehicle in a movement direction of the vehicle; and
a console installed under the carriage,
wherein the robot is installed in the console.

3. The automatic liquid injection system of claim 2, wherein:
a clamp fixed to a lower portion of a front end portion of the robot arm and fastened to or separated from an upper end of the injection gun;
an injection hose connected to the injection gun in one end to supply a liquid to the injection gun;
an unwinder roll rotatably mounted on a front end portion of the robot arm to wind the injection hose by a set force; and
an encoder sensing a rotation position of the unwinder roll.

4. The automatic liquid injection system of claim 3, wherein:
the controller calculates an unwound length of the injection hose from a rotation position of the unwinder roll sensed by the encoder.

5. The automatic liquid injection system of claim 3, wherein:
the controller lowers the front end portion of the robot such that the injection gun is fastened to the inlet.

6. The automatic liquid injection system of claim 5, wherein:
in a state in which the injection gun is fastened to the inlet, the controller unclamps the clamp to separate the clamp from the injection gun.

7. The automatic liquid injection system of claim 6, wherein:
in a state in which the clamp is unclamped from the injection gun, the controller lifts the front end portion of the robot arm, and
the injection hose is unwound from the unwinder roll according to an increase in a distance between the injection gun and the unwinder roll.

8. The automatic liquid injection system of claim 7, wherein:
the controller calculates the distance between the unwinder roll and the injection gun from a sensing signal from the encoder.

9. The automatic liquid injection system of claim 8, wherein:
when a preset amount of liquid is injected to the inlet through the injection hose and the injection gun,
the controller corrects a position of the clamp in a horizontal direction such that the clamp is positioned right above the injection gun according to the calculated distance.

10. The automatic liquid injection system of claim 9, wherein:
after correcting the position of the clamp in the horizontal direction, the controller lowers the front end portion of the robot arm such that the clamp matches the upper end portion of the injection gun and clamps the upper end portion of the injection gun.

11. The automatic liquid injection system of claim 10, wherein:
the controller lifts the front end portion of the robot arm to separate the front end portion from the injection gun and return the robot arm to an initial position.

12. A method for controlling an automatic liquid injection system including a robot controlling a position of a robot arm; an injection gun installed at a front end portion of the robot arm; and a vision installed on one side of the injection gun and imaging an inlet provided in a vehicle, the method comprising:
imaging the inlet of the vehicle using the vision; and
controlling a position of the robot arm to fasten the injection gun to the inlet.

13. The method of claim 12, further comprising:
moving the vehicle at a set rate using the conveyer; and
installing the robot in a console and moving the console above the vehicle in a movement direction of the vehicle.

14. The method of claim 12, wherein:
clamping or unclamping an upper end of the injection gun using a clamp fixed to a front end of the robot arm;
supplying a liquid to the injection gun through an injection hose;
winding the injection hose connected to the injection gun by a set force using an unwinder roll; and
sensing a rotation position of the unwinder roll using an encoder.

15. The method of claim 14, further comprising:
clamping or separating an upper end of the injection gun using the clamp;
supplying a liquid to the injection gun using the injection hose;
winding the injection hose connected to the injection gun by a set force using the unwinder roll; and
sensing a rotation position of the unwinder roll using the encoder.

16. The method of claim 14, further comprising:
calculating an unwound length of the injection hose from a rotation position of the unwinder roll sensed by the encoder.

17. The method of claim 16, further comprising:
lowering a front end portion of the robot such that the injection gun is fastened to the inlet.

18. The method of claim 17, further comprising:
unclamping the clamp to separate the clamp from the injection gun in a state in which the injection gun is fastened to the inlet.

19. The method of claim 18, further comprising:
lifting the front end portion of the robot arm in a state in which the clamp is unclamped from the injection gun,
wherein the injection hose is unwound from the unwinder roll according to an increase in distance between the injection gun and the unwinder roll.

20. The method of claim 19, wherein:
a distance between the unwinder roll and the injection gun is calculated from a sensing signal from the encoder.
